(19) United States
(12) Patent Application Publication
(10) Pub. No.: US 2010/0071045 A1
(43) Pub. Date: Mar. 18, 2010

(54) Information Processing Apparatus and Information Processing Method

(75) Inventor: Junichi Yoshizawa, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/414,400

(22) Filed: Mar. 30, 2009

(30) Foreign Application Priority Data
Sep. 18, 2008 (JP) 2008-239816

(51) Int. Cl. H04L 9/32

(52) U.S. Cl. 726/8

(57) ABSTRACT

An information processing apparatus includes: a first storage module configured to store addresses of websites and pieces of login information being correlated with the addresses, the login information that are required for logging in the respective websites; and a second storage module configured to store the addresses of the websites and command files being correlated with the addresses, the command files containing a login operation procedure to be executed on a login page of a website that includes an entry field for login information.

### CROSS REFERENCE TO RELATED APPLICATIONS)

The present disclosure relates to the subject matters contained in Japanese Patent Application No. 2008-239816 filed on Sep. 18, 2008, which are incorporated herein by reference in its entirety.

### FIELD

The present invention relates to an information processing apparatus and a method for processing information for accessing a website, the apparatus and method for performing a web-based user authentication.

### BACKGROUND

In recent years, with the digitization of television, active discussions have been made about how television should accommodate networking and what network services should be used on the platform of television and related products have been put on the market. For example, TV receivers incorporating what is called a full browser have been provided and TV receivers have come to be able to also use network services that can be used by PCs.

A very large number of websites that provide services or applications exist on the Internet. Each of these websites provides an environment suitable for each user by issuing a user ID for identification of an individual so that his or her preferences are reflected in the service. In the following, websites of this kind will be called Web service providers (WSPs).

One major difference between TV receivers and PCs is a difference in input devices. In PCs, HIDs (human input devices) such as a mouse and a keyboard which enable text input and object operation are used as standard devices. In contrast, in current TV receivers, since they have been used “passively” so far, use of a mouse and a keyboard is very rare and an infrared remote controller which is mainly used for channel control etc. is used as an HID for menu operation etc. On the other hand, the infrared remote controller is a barrier against reception of WSP services because, in general, input through the infrared remote controller takes more time and labor and requires more complicated operations than the mouse/keyboard.

In the above circumstances, various techniques have been proposed which improve the operation method. For example, JP-A-2005-033328 discloses a technique in which a TV program is viewed and information relating to it on a network is read by performing operations using infrared communication or a non-contact IC card.

However, even if means which enables input of information using an external device such as a non-contact IC card is provided as in the technique disclosed in Patent document 1, a procedure of sending a user ID and a password to a server at the time of logging in the server is executed as closed processing in browser software (hereinafter referred to as a browser). Therefore, realization of input/output between the external device and the browser takes time and labor to modify the browser itself. This is a large obstacle for a company that does not develop a browser by itself. Another method is possible in which browser functions are expanded in a general manner using a plug-in or the like. However, in this case, the WSP side needs to generate a dedicated html/script page. In terms of operation, it is difficult to establish a situation that such processing is performed in all WSPs in a cross-sectional manner.

Conventionally, as for the purpose of omitting a login procedure, a technique is available in which a certificate called “cookie” which is issued by a site is stored in a PC locally and input of a user ID and a password is omitted by referring to the cookie in accessing the site from the next time onward. However, TV receivers are more like family devices than PCs and it is not necessarily preferable from the viewpoints of security and privacy that cookies of plural users are stored in a single TV receiver.

### SUMMARY

Therefore, one of objects of the invention is to provide an information processing apparatus and a method for processing information, the apparatus and method performing a web-based user authentication without modifying existing browser software to allow a user to easily login a website.

According to an aspect of the present invention, there is provided an information processing apparatus including: a first storage module configured to store addresses of websites and pieces of login information being correlated with the addresses, the login information that are required for logging in the respective websites; a second storage module configured to store the addresses of the websites and command files being correlated with the addresses, the command files containing a login operation procedure to be executed on a login page of a website that includes an entry field for login information; a receiving module configured to receive an address of an access destination website; an access module configured to access the access destination website having the address received by the receiving module and for receiving a login page provided by the access destination website; a login control module configured to read login information and a command file corresponding to the address accessed by the access module from the first storage module and the second storage module, respectively, the login control module inputting the read-out login information in the entry field of the login page received by the access module according to the login operation procedure contained in the read-out command file; and a login information sending module configured to send the login information that has been input to the login page to the access destination website.

According to another aspect of the present invention, there is provided a method for processing information by an information processing apparatus including: a first storage module configured to store addresses of websites and pieces of login information being correlated with the addresses, the login information that are required for logging in the respective websites; and a second storage module configured to store the addresses of the websites and command files being correlated with the addresses, the command files containing a login operation procedure to be executed on a login page of a website that includes an entry field for login information, wherein the method includes: receiving an address of an access destination website; accessing the access destination website having the received address and receiving a login page provided by the access destination website; reading login information and a command file corresponding to the accessed address from the first storage module and the second storage module, respectively; inputting the read-out login information in the entry field of the login page received by the access step according to login operation procedure contained in the read-out command file; and sending the login information that has been input to the login page to the access destination website.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 schematically shows an example information processing system.

FIG. 2 is a block diagram showing an example configuration of a TV apparatus shown in FIG. 1.

FIG. 3 shows an example login page.

FIG. 4 shows an example html description corresponding to the login page of FIG. 3.

FIG. 5 shows an example login procedure description file.

FIG. 6 is a flowchart showing a login process that is executed by the TV apparatus and an information providing server.

FIG. 7 shows another example configuration of the TV apparatus shown in FIG. 1.

### DETAILED DESCRIPTION OF THE EMBODIMENTS

An information processing apparatus and a method for processing information according to an embodiment of the present invention will be hereinafter described in detail with reference to the accompanying drawings. The invention is not limited to the following embodiment described in below.

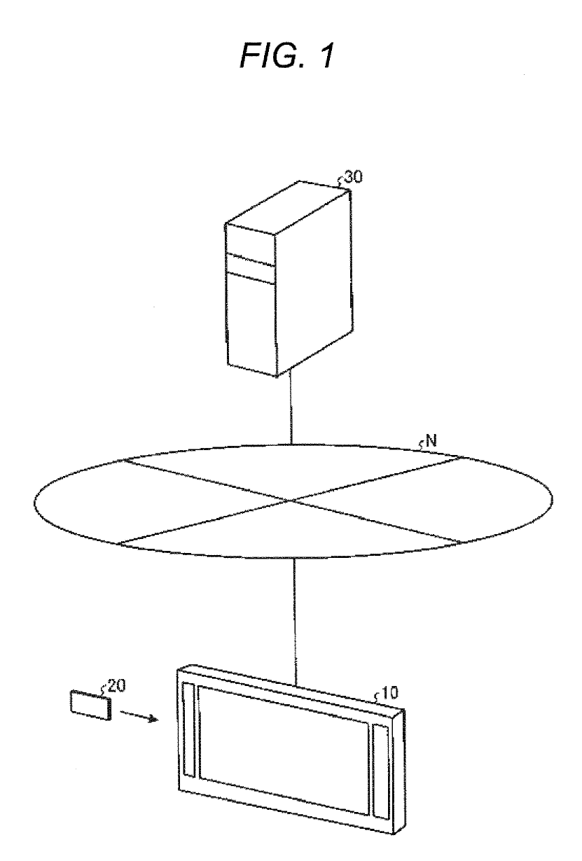

FIG. 1 schematically shows an example information processing system according to the embodiment. As shown in FIG. 1, the information processing system has a TV apparatus 10 as an information processing apparatus which is operated by a user, an external storage device 20 which is connected to the TV apparatus 10, and an information providing server 30 as a Web service provider (WSP).

The TV apparatus 10 is a TV receiver which receives radio waves of a TV broadcast and displays video and outputs audio. The TV apparatus 10 has a function that enables connection to a network N such as the Internet and reception of information that is provided by an external apparatus connected to the network N. More specifically, the TV apparatus 10 has functions of a Web browser capable of connecting to a Web server or functions equivalent to those and performs an HTTP communication with a Web server such as the information providing server 30.

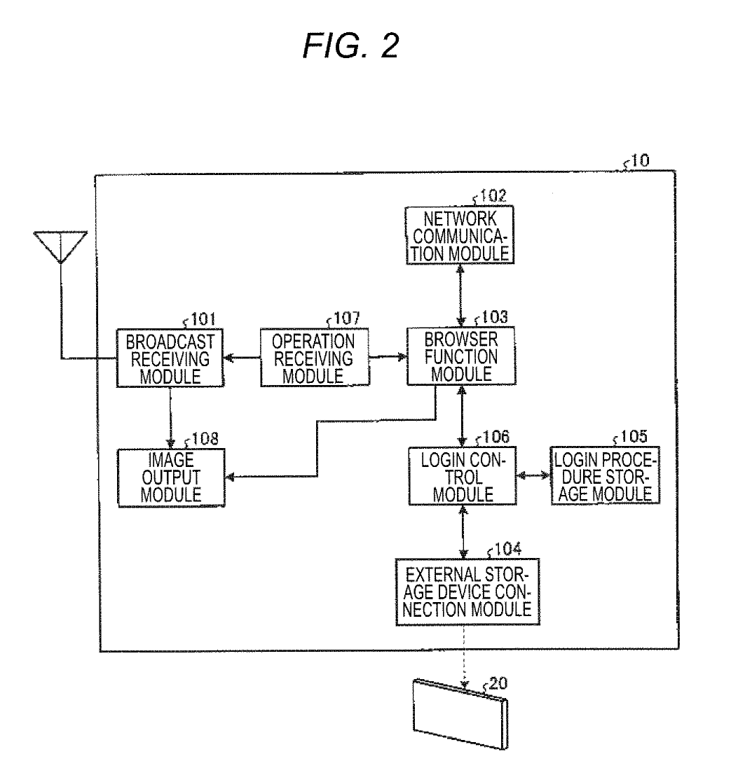

FIG. 2 is a block diagram showing an example configuration of the TV apparatus 10. As shown in FIG. 2, the TV apparatus 10 is provided with a broadcast receiving module 101, a network communication module 102, a browser function module 103, an external storage device connection module 104, a login procedure storage module 105, a login control module 106, an operation receiving module 107, and an image output module 108.

The broadcast receiving module 101, which is provided with a TV tuner, an antenna, etc., generates a video signal by decoding radio waves received from a broadcasting station or the like and outputs video, audio, captions, etc. that are included in the video signal to the image output module 108.

The network communication module 102, which is provided with a network interface card (NIC) etc., controls a communication with an external apparatus (information providing server 30) which is connected to the network N.

The browser function module 103 is an HTTP client having functions of a Web browser or functions equivalent to those. The browser function module 103 performs a communication (HTTP communication) via the network communication module 102 with a site (website) indicated by an access destination URL according to operations of a user received by the operation receiving module 107.

The browser function module 103 outputs a content such as a login page (described later) provided by a connection destination site on the image output module 108 in a display format that corresponds to an HTML description or a script (e.g., JavaScript (registered trademark)) of the content.

The external storage device connection module 104, which is an interface or the like capable of connecting to the external storage device 20, enables access to the external storage device 20 from each functional section (login control module 106) of the TV apparatus 10 by connecting to the external storage device 20.

The external storage device 20, which is, for example, a non-contact IC card, a mobile communication device such as a cell phone or a PHS phone, stores URLs which are addresses of websites such as the information providing server 30 and pieces of login information (user IDs and passwords) that are necessary for logging in the respective websites in such a manner that they are correlated with each other. For example, where the external storage device 20 is a non-contact IC card, the external storage device connection module 104 may be a reader device capable of connecting to the non-contact IC card. Where the external storage device 20 is a mobile communication device, the external storage device connection module 104 may be, for example, a Bluetooth, infrared communication, or USB adaptor device capable of connecting to the mobile communication device.

It is preferable that external storage devices 20 be distributed to users who are to view the TV apparatus 10. It is even preferable that only login information of a user himself or herself be stored in each external storage device 20. No limitation is imposed on the number of sets of a URL and login information stored in each external storage device 20.

The login procedure storage module 105, which is a data structure such as a table stored in a storage device such as an HOD, contains URLs of websites such as the information providing server 30 and login procedure description files which contain login procedures for the respective websites in such a manner that they are correlated with each other. The login procedure description file will be described below.

A login procedure description file contains a operation procedure for reproduction of a procedure that is necessary for logging-in a site (URL) that is correlated with the login procedure description file. The “operation procedure for reproduction of a procedure that is necessary for login” means a procedure from input of a user ID and a password of a login subject user to their entry fields in a login page to their transmission to an access destination site.

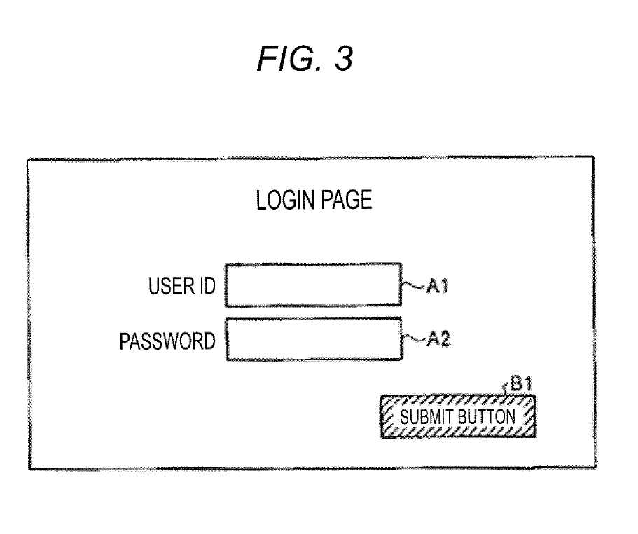

For example, where a login page that is provided by a site is as shown in FIG. 3, a user performs the following operations using an HID:

(1) Focuses on a user ID entry field A1.

(2) Inputs a user ID.

(3) Focuses on a password entry field A2.

(4) Inputs a password.

(5) Focuses on a submit button B1 to be used forgiving an instruction to send the input user ID and password to the connection destination site.

(6) Presses the submit button B1.

The user executes the above procedure using the HID and the browser function module 103 sends the user ID and the password to the connection destination URL according to the above operation procedure. In this example, the login procedure description file contains information that allows the above six steps to be executed in order.

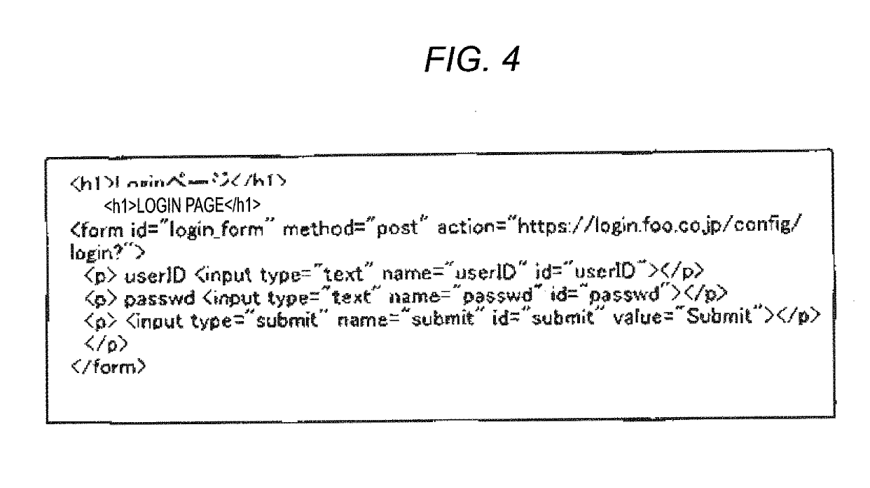

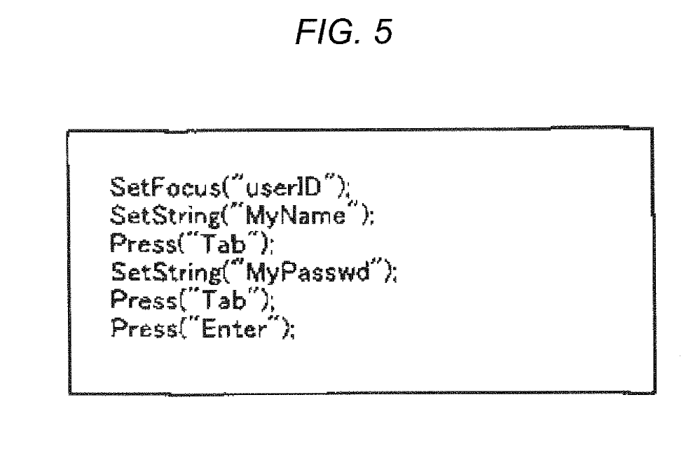

For example, an html description of the login page of FIG. 3 is as shown in FIG. 4, the login procedure description file for this login page contains information shown in FIG. 5. FIG. 5 shows an example login procedure description file.

In FIG. 5, “SetFocus(“userID”)” on line 1 is a command to focus on a space indicated by a tag “<p>userID . . . </p>” of id=“userID” shown in FIG. 4. “SetString(“MyName”)” on line 2 is a command to input a character string “MyName” in the space on which focusing was made by the command on line 1. The character string “MyName” corresponds to a user ID which is part of login information.

“Press(“Tab”) on line 3 is a command to press the Tab key, and is equivalent to a command to focus on the next region, that is, a space indicated by a tag “<p>passwd . . . </p>” of id=“passwd” shown in FIG. 4. “SetString(“MyPasswd”) on line 4 is a command to input a character string “MyPasswd” in the space on which focusing was made by the command on line 3. The character string “MyPasswd” corresponds to a password which is part of the login information.

“Press(“Tab”) on line 5 is a command to press the Tab key, and is equivalent to a command to focus on the next region, that is, a region indicated by a tag “<p><input type=“submit”</p>” of id=“submit” shown FIG. 4. “Press(“Enter”) on line 6 is a command to press the Enter key, that is, a command to press the button on which focusing was made by the command on line 5.

In the example of FIG. 4, it is given that login information be sent to a URL “http://login.foo.co.jp/config/login?” when the submit button B1 is pressed. Therefore, the browser function module 103 sends the input login information to the above URL. It is assumed here that the URL indicates the site provided by the information providing server 30. However, it may be a site provided by a Web server other than the information providing server 30.

The example login procedure description file of FIG. 5 contains the operation procedure from input of login information to its transmission. However, in the invention, the login procedure description file is not limited to such. The login procedure description file may contain another operation procedure or only part of the entire procedure that is necessary for login. For example, the login procedure description file may contain only the commands on lines 1 to 5 shown in FIG. 5.

Sets of a URL and a login procedure description file are stored in the login procedure storage module 105 in advance, and can be updated and subjected to addition, deletion, etc. For example, a login procedure description file may be provided from an external apparatus (e.g., the information providing server 30) via the network communication module 102. In this case, it is appropriate to store the provided login procedure description file in such a manner that it is correlated with a URL of a site that provides the file. Every time a new site (WSP) is accessed, a new login procedure description file may be generated which describes operations made and their order. In this case, it is appropriate to store the provided login procedure description file in such a manner that it is correlated with a URL of the access destination site.

Returning to FIG. 2, the login control module 106 is a functional section which executes, for a user, a procedure for logging in a site (access destination site) that the browser function module 103 has accessed, using login information and a login procedure description file that correspond to a URL of the access destination site.

More specifically, when the login control module 106 has extracted a URL of an access destination site that the browser function module 103 has accessed from the details of the communication, it searches the URLs stored in the external storage device 20 for the same URL as the URL of the access destination site. Upon finding the same URL, the login control module 106 reads the login information that is stored so as to be correlated with this URL from the external storage device 20.

Then, the login control module 106 searches the URLs stored in the login procedure storage module 105 for the same URL as the URL of the access destination site for which the login information has been read out successfully. Upon finding the same URL, the login control module 106 reads the login procedure description file that is stored so as to be correlated with this URL from the login procedure storage module 105.

Then, the login control module 106 inputs the login information that has been read from the external storage to device 20 in entry fields of a login page received by the browser function module 103 and presses a button that commands transmission of the login information according to operations and order described in the login procedure description file that has been read from the login procedure storage module 105. Accordingly, the login control module 106 requests the browser function module 103 to send the login page in which the login information is input.

The operation receiving module 107, which is a functional section for receiving input of operations from a user through the HID such as a remote controller or operation buttons, outputs information indicating received operations to the broadcast receiving module 101 and the browser function module 103. For example, the operation receiving module 107 is an infrared light receiving section capable of receiving infrared light that is emitted from a remote controller or buttons provided on the main body of the TV apparatus 10.

The image output module 108, which is provided with a display device such as an LCD (liquid crystal display) or an OEL (organic electroluminescence) display and audio output devices such as speakers, outputs a video signal that is input from the broadcast receiving module 101 or one of various kinds of contents (video and/or audio) that is input from the browser function module 103.

Among the above functional sections of the TV apparatus 10, the browser function module 103 and the login control module 106 may be implemented as software in such a manner that a CPU (not shown) and given programs cooperate with each other.

Returning to FIG. 1, the information providing server is a Web server (website) which performs an HTTP communication with an HTTP client and functions as a Web service provider (WSP) on the network N.

The information providing server 30 stores user IDs and passwords registered by respective users who use its site in such a manner that they are correlated with each other, and provides services that are suitable for the respective users. In the following, sets of a user ID and a password of respective users stored in the information providing server 30 will be referred to as collation information.

The information providing server 30 provides each HTTP client who accesses its site with a login page having entry fields for a user ID and a password (see FIGS. 3 and 4). Furthermore, the information providing server 30 determines whether an HTTP client is a legitimate user by collating login information (user ID and password) transmitted from the HTTP client using a login page with the collation information stored in advance. The information providing server 30 permits use of its own site only when determined that the HTTP client is a legitimate user.

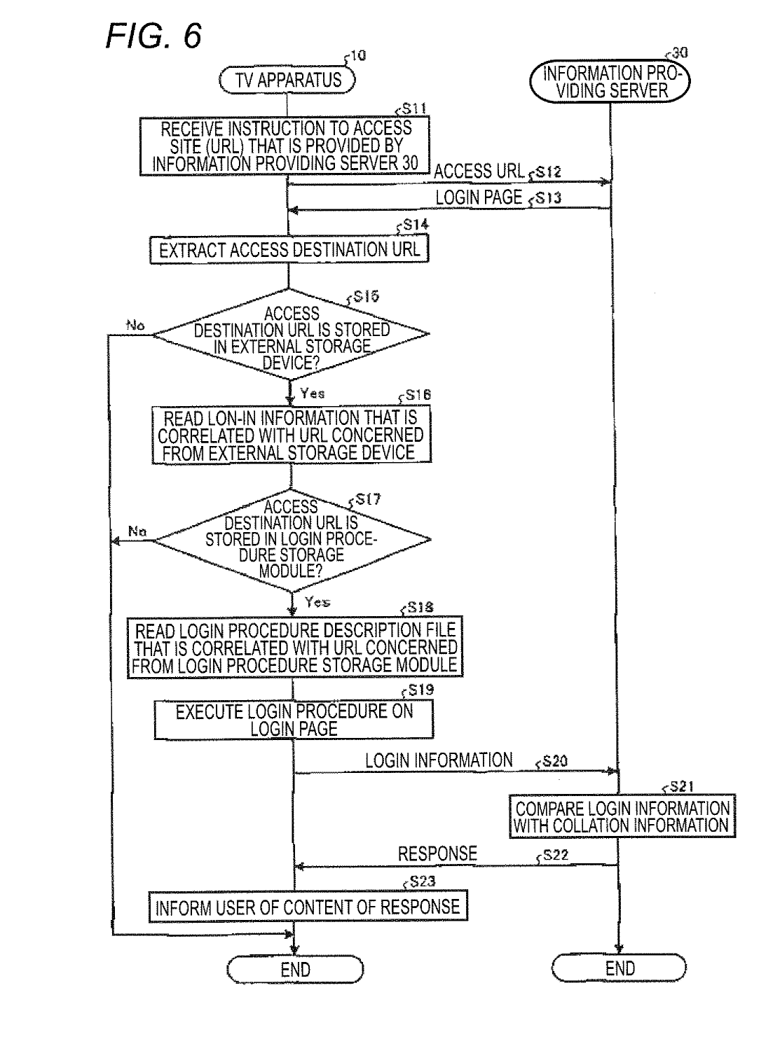

Next, a process that is executed when the TV apparatus 10 accesses the site of the information providing server 30 will be described with reference to FIG. 6. FIG. 6 is a flowchart showing a login process that is executed by the TV apparatus 10 and the information providing server 30.

When instructed by a user to access the site (URL) provided by the information providing server 30 via the operation receiving module 107 at step S11, the browser function module 103 accesses that URL at step S12. The URL may be specified by directly inputting a character string representing the URL. Where the browser function module 103 has a bookmark function, a URL registered in a bookmark list may be designated.

When accessed by the TV apparatus 10, at step S13 the information providing server 30 provides the TV apparatus 10 with a login page for prompting the TV apparatus 10 to login the site indicated by the access destination URL. Upon receiving the login page, the browser function module 103 displays the login page on the display output section 108. Alternatively, control may be made so that the login page is not displayed.

On the other hand, when the browser function module 103 has extracted the access destination URL of the access that was made at step S12 by the browser function module 103 (step S14), at step S15 the login control module 106 refers to the external storage device 20 via the external storage device connection module 104 and determines whether the same URL as the access destination URL is stored in the external storage device 20.

When determined that the same URL as the access destination URL is not stored in the external storage device 20 (S15: no), the login control module 106 finishes the process immediately. In this case, the user is obliged to login the access destination site manually.

When determined that the same URL as the access destination URL is stored (S15: yes), at step S16 the login control module 106 reads the login information that is stored so as to be correlated with this URL from the external storage device 20.

At step S17, the login control module 106 determines whether the same URL as the access destination URL is stored in the login procedure storage module 105. When determined that the same URL is not stored (S17: no), the login control module 106 finishes the process immediately. In this case, the user is obliged to login the access destination site manually.

When determined that the same URL as the access destination URL is stored (S17: yes), at step S18 the login control module 106 reads the login procedure description file that is stored so as to be correlated to this URL from the login procedure storage module 105.

At step S19, the login control module 106 requests the browser function module 103 to send the login information by inputting it in given spaces of the login page provided by the information providing server 30 and pressing a given button included in the login page according to the login information and the login procedure description file that were read out at steps S16 and S18.

Although the above process is such that transmission of login information is requested upon its input, the invention is not limited to such a case. For example, transmission of login information may be requested after the transmission is permitted by the user. This can be done by placing a command to display, via the browser function module 103, a picture for prompting a user to permit the transmission of login information before the command (contained in the login procedure description file) to press the login information transmission button.

Upon receiving the request for transmission of the login information from the login control module 106, at step S20 the browser function module 103 sends the login information that has been input to the login page to the information providing server 30. Upon receiving the login information from the TV apparatus 10, the information providing server 30 performs user authentication at step S21 by comparing the login information with the collation information and sends an authentication result to the TV apparatus 10 at step S22.

Upon receiving the response from the information providing server 30, at step S23 the browser control module 103 outputs information (e.g., authentication success or authentication failure) included in the response to the display output section 108 and thereby informs the user of the content of the response. Then, the process is finished.

As described above, in the TV apparatus 10 according to the invention, the login control module 106 inputs, for a user, login information in a login page according to a login operation procedure that is contained in a login procedure description file, whereby login operations that are conventionally performed by the user with an HID can be automated. Therefore, it becomes possible to easily login a site that performs web-based user authentication without the need for modifying existing browser software.

Although the above embodiment is directed to the case of logging in a WSP site, the invention is not limited to such a case. The invention can be applied to any login destination websites as long as they perform web-based user authentication.

Although the above embodiment is directed to the case that login information includes a user ID and a password, the invention is not limited to such a case. For example, login information may include other information such as a mail address. Where login information includes information other than a user ID and a password, a login procedure description file should contain a operation procedure that is suitable for input of such other information.

Although the above embodiment is directed to the case that sets of a URL and login information are stored in the external storage device 20, the invention is not limited to such a case. Sets of a URL and login information may be stored in a storage device incorporated in the TV apparatus 10, such as an HDD. Such a mode will be described below as a modification to the above embodiment.

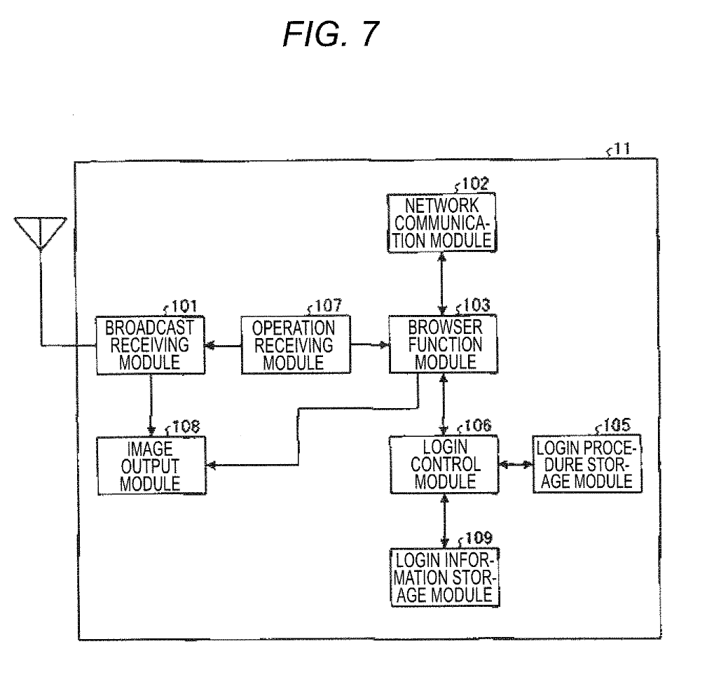

FIG. 7 is a block diagram showing another example configuration of the TV apparatus 10 shown in FIG. 1. This TV apparatus will be referred to as a TV apparatus 11. As shown in FIG. 7, the TV apparatus 11 is equipped with a login information storage module 109 in addition to the broadcast receiving module 101, the network communication module 102, the browser function module 103, the login procedure storage module 105, the login control module 106, the operation receiving module 107, and the display output section 108 which were described above.

The login information storage module 109 contains, in the form of a data structure such as a table that is stored in a storage device such as an HDD, URLs of websites such as the information providing server 30 and pieces of login information (user IDs and passwords) in such a manner that they are correlated with each other.

In this modification, the login control module 106 searches for the URLs stored in the login information storage module 109 for the same URL as the URL of a connection destination site to which the browser function module 103 has connected, and reads login information that is stored so as to be correlated with this URL from the login information storage module 109.

As described above, in the modification, as in the embodiment, login operations that are conventionally performed by a user with an HID can be automated. Therefore, it becomes possible to easily login a site that performs web-based user authentication without the need for modifying existing browser software.

Although the embodiment (and its modification) of the invention has been described above, the invention is not limited to it. Various modifications and various kinds of replacement, addition, etc. are possible without departing from the spirit and scope of the invention.

For example, programs of the TV apparatus 10 or 11 that are necessary for execution of the process of the embodiment (or modification) can be provided so as to be stored in a computer-readable storage medium. The storage medium having any storage form, such as a magnetic disk, an optical disc (e.g., CD-ROM, CD-R, or DVD), a magneto-optical disc (e.g., MO), or a semiconductor memory, the may be employed as long as it can store programs and can be read by a computer.

Programs for execution of the process of the embodiment may be stored in a computer that is connected to a network such as the Internet and provided being downloaded from it over the network.

Although the embodiment is such that the invention is applied to the TV apparatus 10, the invention is not limited to such a case. For example, the invention may be applied to other information processing apparatus such as a PC, a mobile communication terminal such as a cell phone or a PHS phone, and video recoding apparatus such as an HDD recorder.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a first storage module configured to store addresses of websites and pieces of login information being correlated with the addresses, the login information that are required for logging in the respective websites;
a second storage module configured to store the addresses of the websites and command files being correlated with the addresses, the command files containing a login operation procedure to be executed on a login page of a website that includes an entry field for login information;
a receiving module configured to receive an address of an access destination website;
an access module configured to access the access destination website having the address received by the receiving module and for receiving a login page provided by the access destination website;
a login control module configured to read login information and a command file corresponding to the address accessed by the access module from the first storage module and the second storage module, respectively, the login control module inputting the read-out login information in the entry field of the login page received by the access module according to the login operation procedure contained in the read-out command file; and
a login information sending module configured to send the login information that has been input to the login page to the access destination website.

2. The apparatus of claim 1, wherein at least a first command to focus on the entry field included in the login page and a second command to input the login information in the entry field are arranged successively in each command file.

3. The apparatus of claim 2, wherein the login information includes at least a user ID and a password, and
wherein the command file contains a set of the first command and the second command for each input item of the login information.

4. The apparatus of claim 1, wherein the first storage module is an external storage device connected to the apparatus in a manner allowing the login control module to read a set of the address and the login information stored therein.

5. The apparatus of claim 4, wherein the external storage device is a non-contact IC card or a mobile communication terminal.

6. A method for processing information by an information processing apparatus comprising:
a first storage module configured to store addresses of websites and pieces of login information being correlated with the addresses, the login information that are required for logging in the respective websites; and
a second storage module configured to store the addresses of the websites and command files being correlated with the addresses, the command files containing a login operation procedure to be executed on a login page of a website that includes an entry field for login information,
wherein the method comprises:
receiving an address of an access destination website;
accessing the access destination website having the received address and receiving a login page provided by the access destination website;
reading login information and a command file corresponding to the accessed address from the first storage module and the second storage module, respectively;
inputting the read-out login information in the entry field of the login page received by the access step according to login operation procedure contained in the read-out command file; and
sending the login information that has been input to the login page to the access destination website.
